(19) United States
(12) Patent Application Publication
(10) Pub. No.: US 2012/0067600 A1
(43) Pub. Date: Mar. 22, 2012

(54) Method and Apparatus for Wildfire Extinguishing

(75) Inventors: Eugene Bourakov, Carmel, CA (US); Veniamin Bourakov, Carmel, CA (US); Lev Merenzon, Carmel, CA (US)

(73) Assignee: HeliBlanket LLC, Carmel, CA (US)

(21) Appl. No.: 13/249,417

(22) Filed: Sep. 30, 2011

Related U.S. Application Data
(63) Continuation-in-part of application No. PCT/RU2010/000108, filed on Mar. 15, 2010.

(30) Foreign Application Priority Data
Apr. 6, 2009 (RU) 2009112957

(51) Int. Cl. A62C 2/06; A62C 2/00

(52) U.S. Cl. 169/46; 169/49

(57) ABSTRACT

A large size fire blanket folded in one pack is provided and delivered to the area of wild fire over the air by manned or unmanned aircrafts. Being deployed over the air to the wild fire area, the fire blanket attached to aircrafts is unfolding above the fire by stretching it out with aircrafts slowly moving apart until fire blanket is fully unfolded. After that the aircrafts starts simultaneous landing and covering with fire blanket the affected area. In result the fire blanket cuts off oxygen flow to the fire area and extinguish fire therefore. To prevent “hot air balloon” effect, the fire blanket has multiple perforations equally spread along the surface.

### RELATED APPLICATION DATA

This application is a continuation-in-part of PCT application number PCT/RU2010/000108 designating the United States and filed Mar. 15, 2010; which claims the benefit of RU patent application number 2009112957 and filed Apr. 6, 2009 both of which are hereby incorporated by reference in their entireties.

### FIELD OF THE INVENTION

Invention relates to fire extinguishing.

### BACKGROUND OF THE INVENTION

The wild fire is dangerous due to its rapid spreading out and ability to quickly cover vast area. Hot and dry weather with strong wind gusts turns wild fire to the hazardous natural disaster. Commonly used wildfire extinguishing techniques involve fire area localization to prevent fire spreading, and subsequent isolation to allow localized area to be burned out. The most intense fire fighting techniques are applied only when fires threaten residential areas, hazardous industrial facilities, and such.

One known fire extinguishing solution is described in Russian patent No22143295 published on Dec. 27, 1999. It addresses flexible water container delivering water to the area of fire by helicopter. Due to container flexibility, it can be dipped in the water while folded, and grab as much water as possible when helicopter lifts it up.

The downside of this technique is low efficiency due to big and deep reservoir of fresh water needed close to the area of fire. Also, fire extinguishing area is small in size and usually not preventing wild fire from being spreading around.

Another known fire extinguishing solution is presented in Russian patent No22055611 published on Oct. 3, 1996. It describes a half-sphere shaped metal frame covered by incombustible material and delivered to the fire area over the air. It intends to cover up the fire area to prevent oxygen access and stop the fire.

The downside of this solution is the small size of cover frame and as a result small size of initial extinguishing area limited by a heavy weight cover. Big scale wild fire extinguishing is impossible with such cover.

Still another approach is disclosed in Russian patent No22319527, published on Jun. 27, 2007. It describes water container and metal net attached to the aircraft to be delivered to the fire area. The size of metal net when unfolded is 400 sq. meters, and it weight 50 kg. The net is unfolding when dropped from aircraft on the fire area. The water container provides water sprinkling from aircraft on unfolded net on the ground.

The downside of this fire extinguishing method is again the small size of covered area due to heavy metal net even if delivered by several aircrafts. The accuracy of net drop and water drop is not sufficient to stop wild fire spreading.

### SUMMARY OF THE INVENTION

An aspect of the present invention is to significantly improve efficiency of fire extinguishing by drastic increase of covered area and making it applicable for the big scale wild fire.

A further aspect of the invention is a fire extinguishing method, comprising
providing a fire blanket of light-weight incombustible fabric folded in a pack to a fire area;
attaching the folded pack of the fire blanket by incombustible ropes to at least one manned or unmanned aerial vehicle; and
unfolding the fire blanket from the folded pack over the fire area by pulling with at least one manned or unmanned aerial vehicle flying over the fire area.

An embodiment of the invention comprises delivering, by at least one manned or unmanned aerial vehicle, the folded pack of the fire blanket airborne to the fire area.

According to an embodiment of the invention said unfolding comprises
unfolding the fire blanket from the folded pack airborne above the fire area by moving at least one manned or unmanned aerial vehicle apart from each other to different directions;
descending the at least one manned or unmanned aerial vehicle and the attached unfolded fire blanket towards the ground so as to cover the fire area by the unfolded fire blanket, thereby preventing oxygen flow to the fire area and extinguishing the fire.

According to an embodiment of the invention said unfolding comprises
anchoring at least one point of the fire blanket to ground at the fire area;
unfolding the fire blanket from the folded pack airborne above the fire area by moving the at least one manned or unmanned aerial vehicle in a direction away from the at least anchoring point;
descending the at least one manned or unmanned aerial vehicle and the attached unfolded fire blanket towards the ground so as to cover the fire area by the unfolded fire blanket, thereby preventing oxygen flow to the fire area and extinguishing the fire.

According to an embodiment of the invention the fire blanket comprises perforations to prevent a hot air balloon effect when unfolded above the fire area.

According to an embodiment of the invention the fire area covered by the unfolded fire blanket is at least several hundreds of square meters, preferably thousands of square meters.

A further aspect of the invention is a method of protecting large objects or areas from fire, comprising
providing a fire blanket of light-weight incombustible fabric folded in a pack to a large object or area to be protected from fire;
attaching the folded pack of the fire blanket by incombustible ropes to at least one manned or unmanned aerial vehicle;
unfolding the fire blanket from the folded pack over the large object or area to be protected from fire by pulling with the at least one manned or unmanned aerial vehicle flying over the fire area, thereby enclosing the large object or area within a fireproof protective compartment.

According to an embodiment of the invention a method according to claim 7, comprising delivering, by the at least one manned or unmanned aerial vehicle, the folded pack of the fire blanket airborne to the large object or area to be protected from fire.

According to an embodiment of the invention said unfolding comprises
unfolding the fire blanket from the folded pack airborne above the large object or area to be protected from fire by moving the at least one manned or unmanned aerial vehicle apart from each other to different directions;
descending the at least one manned or unmanned aerial vehicle and the attached unfolded fire blanket towards the ground so as to cover the large object or area by the unfolded fire blanket, thereby enclosing the large object or area within a fireproof protective compartment.

According to an embodiment of the invention said unfolding comprises
anchoring at least one point of the fire blanket to ground at the large object or area to be protected from fire;
unfolding the fire blanket from the folded pack airborne above the large object or area by moving the at least one manned or unmanned aerial vehicle in a direction away from the at least anchoring point;
descending the at least one manned or unmanned aerial vehicle and the attached unfolded fire blanket towards the ground so as to cover the large object or area by the unfolded fire blanket, thereby enclosing the large object or area within a fireproof protective compartment.

According to an embodiment of the invention the fire blanket comprises perforations to prevent a hot air balloon effect when unfolded above fire.

According to an embodiment of the invention the surface area of the unfolded fire blanket is at least several hundreds of square meters, preferably thousands of square meters.

A further aspect of the invention is fire extinguishing and protecting equipment, comprising
a fire blanket of light-weight incombustible fabric folded in a pack;
incombustible ropes for attachment of the fire blanket to at least one manned or unmanned aerial vehicle to enable at least unfolding the fire blanket from the pack at a target site;
perforations in the fire blanket to prevent a hot air balloon effect when the fire blanket is unfolded above fire; and
the surface area of the unfolded fire blanket being at least several hundreds of square meters, preferably thousands of square meters.

### BRIEF DESCRIPTION OF THE DRAWINGS

In the following the invention will be described in greater detail by means of exemplary embodiments with reference to the attached drawings, in which

FIG. 1 is a perspective view of wild fire extinguishing system and its elements in accordance with the invention;

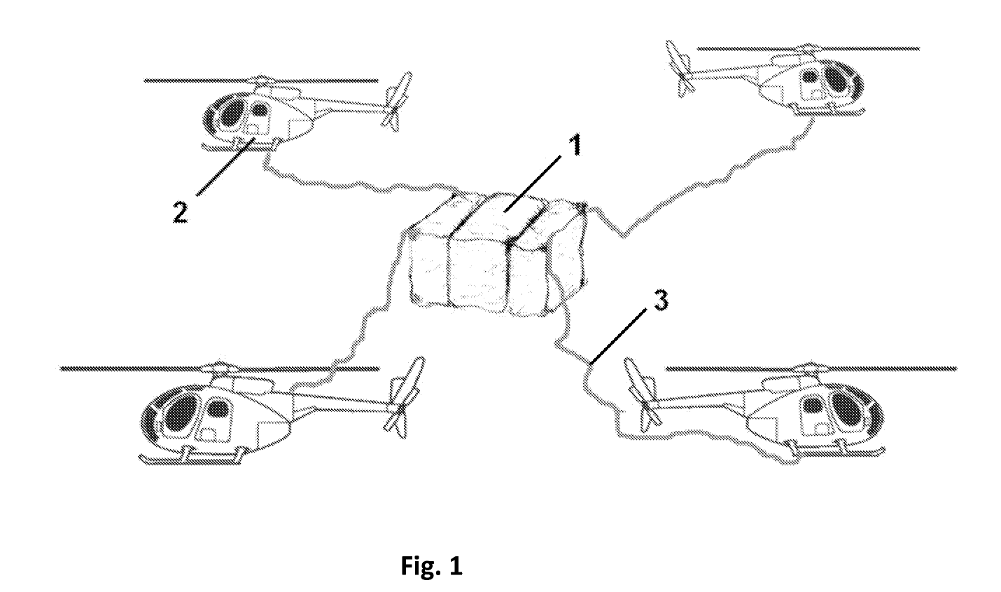

FIG. 2 is a perspective view of wild fire extinguishing system with fire blanket stretched out above the wild fire area; and

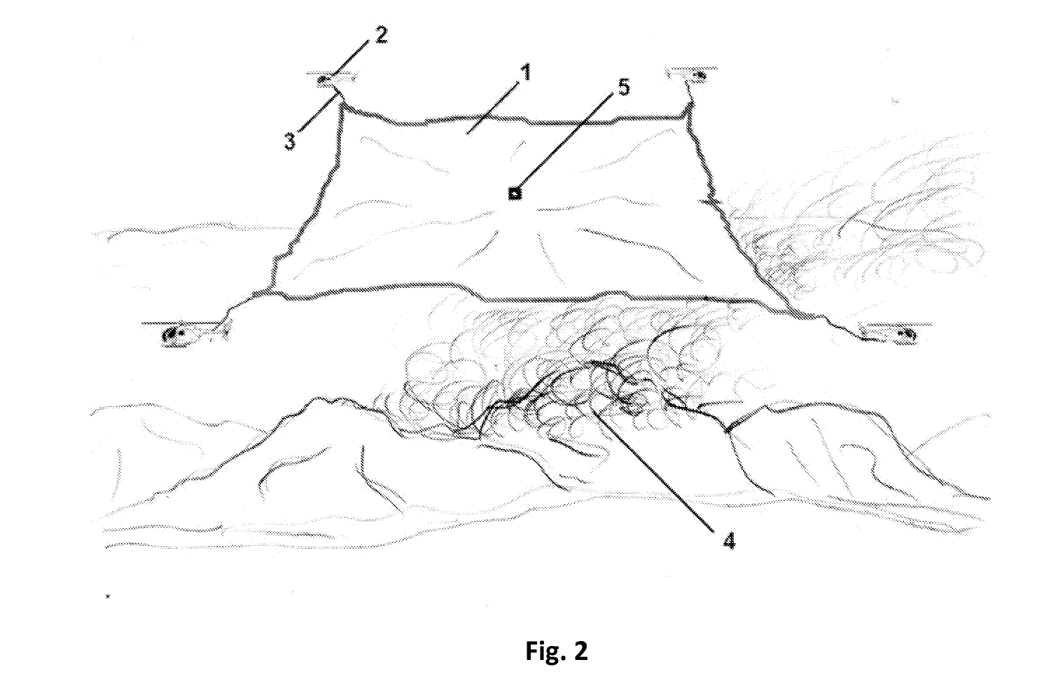

FIG. 3 is a perspective view of wild fire extinguishing system with fire blanket covering the area of wild fire to cut off oxygen flow and stop fire.

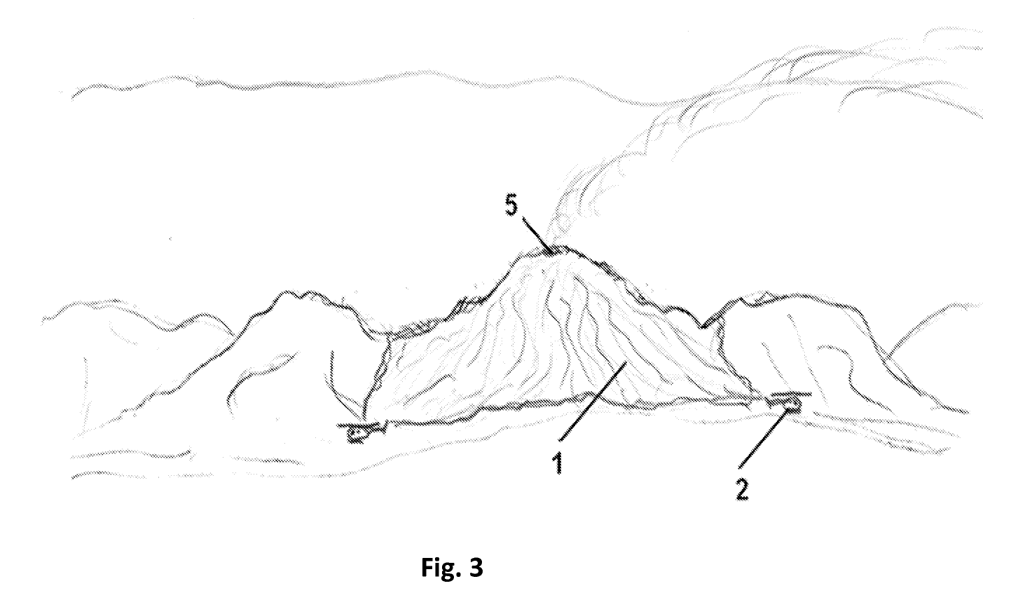

### SOME EMBODIMENTS OF THE INVENTION

It is appreciated that the following embodiments are exemplary. Furthermore, although the specification may in various places refer to “an”, “one”, or “some” embodiment(s), reference is not necessarily made to the same embodiment(s), or the feature in question does not only apply to a single embodiment. Single features of different embodiments may be combined to provide further embodiments.

According to an aspect of the invention, efficiency of fire extinguishing may be significantly improved drastic increase of covered area and making it applicable for the big scale wild fire. According to the invention embodiments, a large size fire blanket 1 folded in one pack may be provided and delivered to the area of wild fire 4 over the air by at least one manned or unmanned aircraft 2, primarily helicopters. However, the invention is not intended to be restricted to the airborne delivery of the fire blanket 1, although this delivery method has some advantages, but also other delivery means, such as ground vehicles or water vehicles, may be used instead. Being deployed to the wild fire area 4, the fire blanket 1 may be unfolded by attaching it to the aircrafts 2 and by stretching it out with aircrafts slowly moving apart until fire blanket is fully unfolded to cover the affected area 4. After that the aircrafts may start simultaneous landing and cover with fire blanket the affected area such that the fire blanket to cuts off oxygen flow to the fire area 4 and stops fire therefore. To prevent “hot air balloon” effect, the fire blanket 1 has multiple perforations 5, e.g. multiple perforations equally spread along the surface, such as at intervals of 10% of the length and width of the blanket. For example, if length of the blanket is 1 km, then perforation may be provided every 100 meters.

The fire blanket 1 may be a fabric (cloth) made of incombustible material with a high strength-to-weight ratio. The fire blanket of such material has a capability of covering much bigger in size area affected by wild fire.

According to an exemplary embodiment, the fire blanket 1 may be a fabric (cloth) made of incombustible nano-modified carbon fiber material with a high strength-to-weight ratio. The properties of carbon fiber such as high tensile strength, low weight, and low thermal expansion make it very popular in aerospace, civil engineering, and military. Its heat resistance allows withstanding high temperatures up to several thousand degrees Celsius. When woven into fabric from tiny filament yarn it can be considered as an “incombustible silk”. For example, if carbon fiber with 50 grams per square meter weight is used, then for 300×300 meters fire blanket 1, its approximate weight is 4500 kg. This weight can be lifted up by one or more heavy weight helicopters.

According to another exemplary embodiment the fire blanket 1 may be made of incombustible material MTP-2-2. The fire blanket 2 made of incombustible material MTP-2-2. According to TU8729-006-00300311-99, this material has weight ratio of 90 grams per square meter. Thus, for example, with 5000 kg of this material it is possible to make a fire blanket having a surface area of approximately 50000 square meters (e.g. a square fire blanket with equal length and width of 224 meters each). Thus in this example, the weight of fire blanket would be approximately 5000 kg. This weight can be lifted up by one or more helicopters.

According to an exemplary embodiment of the invention, in order to prevent “hot air balloon” effect and to minimize air volume under the fire blanket, the fire blanket 1 may be provided with multiple perforations 5. Although, for the sake of simplicity, only one perforation 5 is shown in the drawings, there may be any number of perforations 5 in the fire blanket. According to an embodiment of the invention, multiple perforations 5 may be substantially equally spread along the surface of fire blanket. According to an embodiment of the invention the perforations may occupy several percentages, preferably approximately 10% or more of the length or width of the fire blanket. For example, in the exemplary square fire blanket with sides of 224 meters, the perforations 5 may be substantially equally spread along the surface of fire blanket with a distance of 22.4 meters between the perforations 5. Thus, the fire blanket may have 81 square perforations of size 0.5×0.5 meter or 81 circle-shaped perforations with a diameter 0.6 m, for example. The total area of the perforations would be 20.25 square meters or 22.9 square meters, respectively, i.e. approximately 0.05% of the total area of the fire blanket.

As another example, in the case of the 300×300 meters fire blanket 1 of carbon fiber, the fire blanket 1 may have multiple perforations 5, each approximately 0.1-1 meter in diameter equally spread along the surface at 10% of its length and width. The distance between perforations 5 for that size of fire blanket 1 may be 30 meters, equally spread accross the fire blanket 1, the number of the perforations being 81.

Since the scale of fire and consequently the size of the fire blanket 1 in a specific situation are unpredictable, fire blankets of smaller size may be provided and the final fire blanket of the required size is assembled on demand from several smaller blankets before folding and packing of the final blanket for transportation. According to an embodiment of the invention, a stitching technique may be used for assembling. In other words, the fire blanket 1 of an appropriate size may be assembled by stitching smaller pieces of fire blankets together (e.g. pieces with a minimal size of 100 by 100 meters) with subsequent folding and packing the resulting fire blanket 1 to be delivered to the wild fire area 4.

According to another embodiment of the invention, to minimize system deployment time, different sizes of fire blankets 1 may be pre-packed and stored at fire stations or like.

An exemplary practical implementation of the inventive fire extinguishing is described below using four helicopters 2 to deliver and unfold the fire blanket 1 in fire area 4. More specifically, when fire alarm received, a fire blanket 1 of an appropriate size and an appropriate number of helicopters 2 will be assigned. The fire blanket pack 1 is attached to helicopters 2 with incombustible ropes 3. Helicopters 2 will synchronously take off, lifting up the fire blanket pack 1 and proceeding to the area of wild fire 4. When the helicopters 2 have arrived above the fire area 4, e.g. at relatively high altitude, such as at altitude of 500-1000 meters, the helicopters 2 may unlock fire blanket packing mechanism and start moving apart unfolding fire blanket 1 in the air in a way similar to parachute deployment. When fire blanket 1 is fully stretched in the air, the helicopters 2 may make a synchronous descending maneuver, each landing away from the fire area 4. Helicopter's weight may be used as an anchor to fix the fire blanket 1 in the area of fire 4. Additional weights, press studs, hooks etc. may be used along the perimeter of the fire blanket 1 to secure fire blanket 1 and prevent oxygen flow to the burning area 4. The exothermal reaction causing flame will stop when oxygen under the fire blanket 1 ran out. That will complete wild fire extinguishing.

In another exemplary practical implementation of the inventive fire extinguishing, after delivery to the fire area 4, the fire blanket 1 may be rolled over the fire area 4 by one or two helicopters 2 while another end of the fire blanket 1 is anchored to the ground. This approach may be especially suitable in extinguishing residential and industrial fire with relatively smaller size of fire blanket 1.

An exemplary practical implementation of the inventive fire extinguishing is described below using two helicopters 2 to deliver and unfold the fire blanket 1 in fire area 4. More specifically, when fire alarm received, a fire blanket 1 of an appropriate size and an appropriate number of helicopters 2 will be chosen. The fire blanket pack 1 is attached to helicopters 2 with incombustible ropes 3. Helicopters 2 will synchronously take off, lifting up the fire blanket pack 1 and proceeding to the area of wild fire 4. When the helicopters 2 have arrived above the fire area 4, the helicopters 2 may unlock fire blanket packing mechanism and start moving apart unfolding fire blanket 1 in the air in one direction. As a result, the fire blanket pack is unfolded in one direction (e.g. width). When the full width of the fire blanket 1 is stretched in the air, the helicopters 2 may make a synchronous descending maneuver, each landing away from the same side of the fire area 4. Helicopter's weight may be used as an anchor to fix the fire blanket 1 in the area of fire 4. Then additional weights, press studs, hooks etc. may be used along the unfolded side of the fire blanket 1 to secure fire blanket 1. Then the helicopters 2 may unlock fire blanket packing mechanism also in the other direction (e.g. the length), synchronously take off and moving away from the secured side of the fire blanket 1, thereby unfolding the fire blanket pack 1 lengthwise in the air in the air in a way similar to parachute deployment. When fire blanket 1 is fully stretched in the air, the helicopters 2 may make a synchronous descending maneuver, each landing away from the opposite side of the fire area 4. Helicopter's weight may again be used as an anchor to fix the fire blanket 1 in the area of fire 4. Additional weights, press studs, hooks etc. may again be used along the perimeter of the fire blanket 1 to secure fire blanket 1 and prevent oxygen flow to the burning area 4. The exothermal reaction causing flame will stop when oxygen under the fire blanket 1 ran out. That will complete wild fire extinguishing.

Similarly any number of helicopters may be used for extinguishing the fire.

Present invention may also be employed in extinguishing residential and industrial fire with relatively smaller size of fire blanket. In such cases a slightly different technique of fire blanket deployment may be engaged. After delivery to the area, the fire blanket may be rolled over the fire area by one or two helicopters while another end of blanket is anchored to the ground.

Embodiments of the present invention may also be employed as fire protection technique for the highly important areas and constructions, such as historical architectural buildings, industrial structures, nuclear power stations etc. In such cases the fire blanket of appropriate size should be prepared ahead of the disastrous fire, stored in the area, and be ready to cover the area when fire is approaching to it. More specifically, the fire blanket 1 may unfolded from the folded pack over the object or area to be protected from fire in a similar manner as described above with reference to exemplary fire extinguishing embodiment, thereby enclosing the object or area within a fireproof protective compartment. Thus, in the protective use, the fire blanket 1 protects the covered object from the outside fire. This method may also be used to form “fire walls” to block the fire in a restricted area by covering surrounding area(s) with the fire blanket(s) 1.

It will be obvious to a person skilled in the art that the inventive concept can be implemented in various ways. The invention and its embodiments are not limited to the examples described above but may vary within the spirit and scope of the claims.

What is claimed:

1. A fire extinguishing method, comprising
providing a fire blanket of light-weight incombustible fabric folded in a pack to a fire area;
attaching the folded pack of the fire blanket by incombustible ropes to at least one manned or unmanned aerial vehicle; and
unfolding the fire blanket from the folded pack over the fire area by pulling with the at least one manned or unmanned aerial vehicle flying over the fire area.

2. A method according to claim 1, comprising delivering, by the at least one manned or unmanned aerial vehicle, the folded pack of the fire blanket airborne to the fire area.

3. A method according to claim 1, wherein said unfolding comprises
unfolding the fire blanket from the folded pack airborne above the fire area by moving the at least one manned or unmanned aerial vehicle apart from each other to different directions;
descending the at least one manned or unmanned aerial vehicle and the attached unfolded fire blanket towards the ground so as to cover the fire area by the unfolded fire blanket, thereby preventing oxygen flow to the fire area and extinguishing the fire.

4. A method according to claim 1, wherein said unfolding comprises
anchoring at least one point of the fire blanket to ground at the fire area;
unfolding the fire blanket from the folded pack airborne above the fire area by moving the at least one manned or unmanned aerial vehicle in a direction away from the at least anchoring point;
descending the at least one manned or unmanned aerial vehicle and the attached unfolded fire blanket towards the ground so as to cover the fire area by the unfolded fire blanket, thereby preventing oxygen flow to the fire area and extinguishing the fire.

5. A method according to claim 1, wherein the fire blanket comprises perforations to prevent a hot air balloon effect when unfolded above the fire area.

6. A method according to claim 1, wherein the fire area covered by the unfolded fire blanket is at least several hundreds of square meters, preferably thousands of square meters.

7. A method of protecting large objects or areas from fire, comprising
providing a fire blanket of light-weight incombustible fabric folded in a pack to a large object or area to be protected from fire;
attaching the folded pack of the fire blanket by incombustible ropes to at least one manned or unmanned aerial vehicle;
unfolding the fire blanket from the folded pack over the a large object or area to be protected from fire by pulling with the at least one manned or unmanned aerial vehicle flying over the object or area, thereby enclosing the large object or area within a fireproof protective compartment.

8. A method according to claim 7, comprising delivering, by the at least one manned or unmanned aerial vehicle, the folded pack of the fire blanket airborne to the large object or area to be protected from fire.

9. A method according to claim 7, wherein said unfolding comprises
unfolding the fire blanket from the folded pack airborne above the large object or area to be protected from fire by moving the at least one manned or unmanned aerial vehicle apart from each other to different directions;
descending the at least one manned or unmanned aerial vehicle and the attached unfolded fire blanket towards the ground so as to cover the large object or area by the unfolded fire blanket, thereby enclosing the large object or area within a fireproof protective compartment.

10. A method according to claim 7, wherein said unfolding comprises
anchoring at least one point of the fire blanket to ground at the large object or area to be protected from fire;
unfolding the fire blanket from the folded pack airborne above the large object or area by moving the at least one manned or unmanned aerial vehicle in a direction away from the at least anchoring point;
descending the at least one manned or unmanned aerial vehicle and the attached unfolded fire blanket towards the ground so as to cover the large object or area by the unfolded fire blanket, thereby enclosing the large object or area within a fireproof protective compartment.

11. A method according to claim 7, wherein the fire blanket comprises perforations to prevent a hot air balloon effect when unfolded above fire.

12. A method according to claim 7, wherein the surface area of the unfolded fire blanket is at least several hundreds of square meters, preferably thousands of square meters.

13. A fire extinguishing and protecting equipment, comprising
a fire blanket of light-weight incombustible fabric folded in a pack;
incombustible ropes for attachment of the fire blanket to at least one manned or unmanned aerial vehicle to enable at least unfolding the fire blanket from the pack at a target site;
perforations in the fire blanket to prevent a hot air balloon effect when the fire blanket is unfolded above a fire; and
the surface area of the unfolded fire blanket being at least several hundreds of square meters, preferably thousands of square meters.
